(19) United States
(12) Patent Application Publication
(10) Pub. No.: US 2012/0248996 A1
(43) Pub. Date: Oct. 4, 2012

(54) START AUXILIARY DEVICE, BALLAST AND ILLUMINATION DEVICE

(75) Inventors: Wei Chen, Panyu (CN); Shudong Li, Panyu (CN)

(73) Assignee: OSRAM AG, Muenchen (DE)

(21) Appl. No.: 13/515,290

(22) PCT Filed: Nov. 19, 2010
(86) PCT No.: PCT/EP2010/067840

§ 371 Date: Jun. 12, 2012

(30) Foreign Application Priority Data
Dec. 16, 2009 (CN) 200910262014.X

(51) Int. Cl. H05B 41/14

(52) U.S. Cl. 315/187

(57) ABSTRACT

The present invention relates to a start auxiliary device for driving a gas discharge lamp cluster, the gas discharge lamp cluster comprising n gas discharge lamps connected in series, the start auxiliary device comprises: a primary start circuit including a primary start capacitor (C1) and a primary start inductor (L1); and a step-up unit (T1) including a first terminal (101), a second terminal (102), and a third terminal (103). When the step-up unit (T1) is excited by the primary start capacitor (C1) and the primary start inductor (L1) of the primary start circuit, the step-up unit (T1) outputs a high auxiliary start voltage at the third terminal (103) to start the respective gas discharge lamps in the gas discharge lamp cluster. In addition, the present invention also relates to a ballast having the start auxiliary device and an illumination device having the ballast.

### FIELD OF THE INVENTION

The present invention generally relates to driving of a gas discharge lamp, particularly to a start auxiliary device for driving a gas discharge lamp cluster. In addition, the present invention also relates to a ballast having the start auxiliary device and an illumination device.

### BACKGROUND OF THE INVENTION

When a plurality of gas discharge lamps are coupled in series to form a gas discharge lamp cluster, there is usually difficulty in the start of the respective gas discharge lamps in the gas discharge lamp cluster owing to the voltage division effect. In order to ensure a normal start of the respective gas discharge lamps in the gas discharge lamp cluster, a primary start capacitor and auxiliary start capacitors are provided in the ballast in the prior art, and a sum of the numbers of the primary start capacitor and the auxiliary start capacitors correspond to the number of the gas discharge lamps in the gas discharge lamp cluster. Nevertheless, it is still impossible to ensure complete normal start of the respective gas discharge lamps in the gas discharge lamp cluster without being influenced by the voltage division caused by the series connection. In addition, the great number of start capacitors will result in a large volume of the ballast on the one hand and a higher manufacturing cost on the other hand. Meanwhile, in the prior art, in order to further improve the start of the respective gas discharge lamps, there is also a solution of making the inductance of the primary start inductor in the ballast to be large, but this also makes the volume of the ballast to be large; besides, the primary start inductor with large inductance also results in the disadvantage of high manufacturing cost.

### SUMMARY OF THE INVENTION

In view of the above defects in the prior art, the embodiment of the present invention provides a start auxiliary device for driving a gas discharge lamp cluster. The gas discharge lamp cluster includes n gas discharge lamps that are connected in series, in which n is a natural number greater than or equal to 2. The start auxiliary device includes: a primary start circuit having primary start capacitors and primary start inductors that are coupled in series; and a step-up unit including a first terminal, a second terminal and a third terminal, in which the first terminal of the step-up unit is coupled to one terminal of the primary start capacitor via the filament terminal of the first gas discharge lamp of the gas discharge lamp cluster that is not coupled to other gas discharge lamps of gas discharge lamp cluster, the second terminal of the step-up unit is coupled to the other terminal of the primary start capacitor via the filament terminal of the n^{th} gas discharge lamp that is not coupled to other gas discharge lamps of gas discharge lamp cluster, the coupling point of the filament of the first gas discharge lamp and the primary start capacitor is coupled to one terminal of the primary start inductor, and the other terminal of the primary start inductor forms a feeding input terminal of the start auxiliary device, and the third terminal of the step-up unit is coupled to the filament terminals of them and the (m+1)^{th} gas discharge lamps that are coupled to each other, so that the output voltage at the third terminal of the step-up unit is sufficient to supply start voltage for the respective gas discharge lamps in the gas discharge lamp cluster when the step-up unit is excited by the primary start circuit, wherein m≦n−1 and m is a natural number.

Further, the embodiment of the present invention provides a ballast having the start auxiliary device. The ballast further comprises a power supply circuit, an output terminal of which is coupled to the feeding input terminal of the start auxiliary device so as to supply the electric energy needed for operation of the start auxiliary device.

In addition, the embodiment of the present invention also provides an illumination device. The illumination device comprises an illumination unit and the ballast for driving the illumination unit.

### BRIEF DESCRIPTION OF THE DRAWINGS

The present invention can be better understood by referring to the following descriptions in conjunction with the accompanying drawings. Throughout the drawings, the same or similar reference numerals indicate the same or similar components. The drawings together with the following detailed descriptions are included in the specification and form a part thereof. Meanwhile, they are used to further illustrate the preferred embodiments of the present invention and to explain the principle and advantages of the present invention. In the drawings:

FIG. 1 shows a start auxiliary circuit for a gas discharge lamp cluster composed of two gas discharge lamps connected in series in the prior art;

FIG. 2 shows a schematic drawing of the start auxiliary device for a gas discharge lamp cluster composed of two gas discharge lamps connected in series according to one embodiment of the present invention;

FIG. 3 shows a schematic drawing of the start auxiliary device for a gas discharge lamp cluster composed of three gas discharge lamps connected in series according to one embodiment of the present invention;

FIG. 4 shows a schematic drawing of the start auxiliary device for a gas discharge lamp cluster composed of n gas discharge lamps connected in series according to one embodiment of the present invention;

FIG. 5a shows a schematic block diagram of a specific example of the step-up unit in the start auxiliary device for a gas discharge lamp cluster according to one embodiment of the present invention;

FIG. 5b shows a schematic block diagram of a variation of the step-up unit as shown in FIG. 5a;

FIG. 6a shows a schematic drawing of the start auxiliary device having a plurality of accelerating start units at the left part of the gas discharge lamp cluster according to one embodiment of the present invention;

FIG. 6b shows a schematic drawing of another way of implementation of the start auxiliary device having a plurality of accelerating start units at the left part of the gas discharge lamp cluster according to one embodiment of the present invention;

FIG. 6c shows a schematic drawing of the start auxiliary device having a plurality of accelerating start units at the right part of the gas discharge lamp cluster according to one embodiment of the present invention;

FIG. 6d shows a schematic drawing of the start auxiliary device having a plurality of accelerating start units at both the left part and the right part of the gas discharge lamp cluster according to one embodiment of the present invention;

FIG. 6e shows a schematic drawing of another way of implementation of the start auxiliary device having a plurality of accelerating start units at both the left part and the right part of the gas discharge lamp cluster according to one embodiment of the present invention;

FIGS. 7a-7b respectively show, in a magnifying form, the ways of implementation of the coupling relations as shown by the dashed block A in FIG. 6a;

FIGS. 8a-8c respectively show, in a magnifying form, the ways of implementation of the coupling relations as shown by the dashed block B in FIG. 6d;

FIGS. 9a-9b respectively show, in a magnifying form, the ways of implementation of the coupling relations as shown by the dashed blocks C and D in FIG. 6d;

FIG. 10 shows a ballast having a start auxiliary device for a gas discharge lamp cluster according to one embodiment of the present invention.

### DETAILED DESCRIPTION OF THE EMBODIMENTS

Hereinafter, the exemplary embodiments of the present invention will be described with reference to the drawings. For the sake of clarity and concision, the specification does not describe all the features of the practical embodiments. However, it should be understood that in the process of developing any of such embodiments, many decisions particular to the embodiments must be made, so that the specific goals of the developers can be achieved, and such decisions may vary with different embodiments.

It should also be noted herein that in order not to obscure the present invention by unnecessary details, only the structures of the devices that are closely related to the solution of the present invention are shown in the drawings, while other details that are not so much related to the present invention are omitted

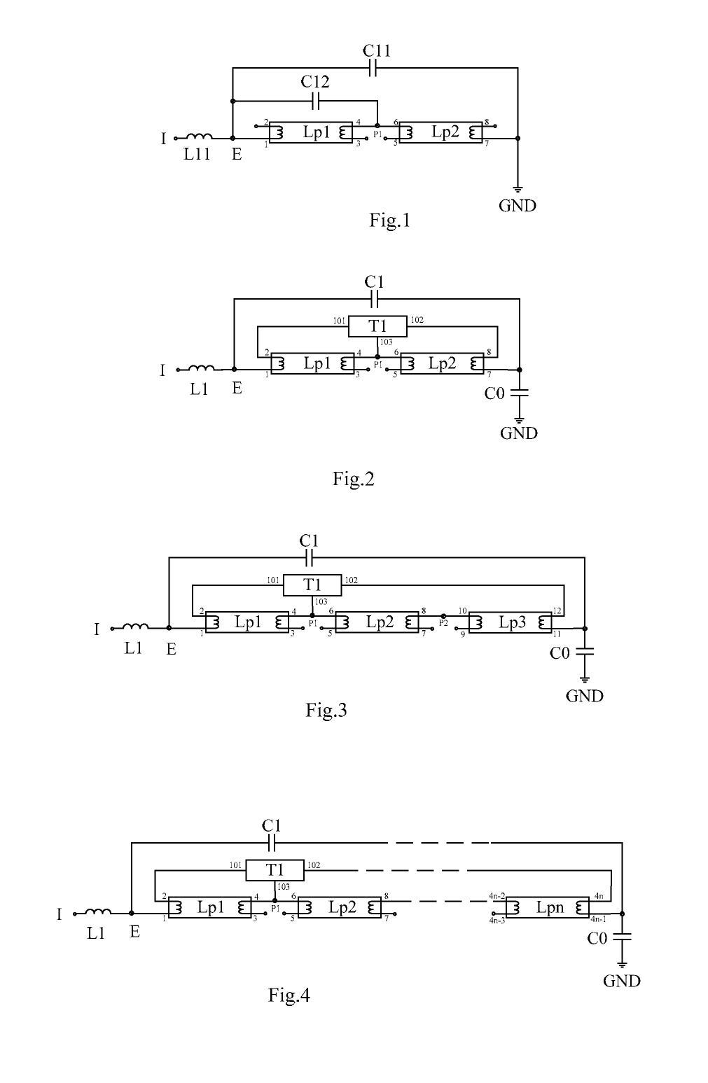

FIG. 1 shows a start auxiliary circuit for a gas discharge lamp cluster composed of two gas discharge lamps connected in series in the prior art. Two gas discharge lamps Lp1 and Lp2 coupled in series are shown in FIG. 1, in which one filament terminal 4 of the gas discharge lamp Lp1 is coupled to one filament terminal 6 of the gas discharge lamp Lp2. A primary start circuit is provided in the start auxiliary circuit, which comprises a primary start inductor L11 and a primary start capacitor C11. The filament terminal 1 of the gas discharge lamp Lp1 is coupled to the power supply circuit (not shown in this Figure) at the feeding input terminal I of the start auxiliary circuit via the primary start inductor L11. The filament terminals 2 and 3 of the gas discharge lamp Lp1 and the filament terminals 5 and 8 of the gas discharge lamp Lp2 are suspended, respectively. Of course, the respective filament terminals of the gas discharge lamps Lp1 and Lp2 can also be shorted, namely, the filament terminals 1 and 2 of the gas discharge lamp Lp1 are shorted, the filament terminals 3 and 4 of the gas discharge lamp Lp1 are shorted, the filament terminals 5 and 6 of the gas discharge lamp Lp2 are shorted, and the filament terminals 7 and 8 of the gas discharge lamp Lp2 are shorted. In addition, an auxiliary start capacitor C12 is provided in the start auxiliary circuit. The primary start capacitor C11 is connected in parallel to the two ends of the gas discharge lamp cluster composed of gas discharge lamps Lp1 and Lp2, namely, one terminal of the primary start capacitor C11 is coupled to the filament terminal 1 of the filament of the gas discharge lamp Lp1 that is not connected in series to the filament of the gas discharge lamp Lp2, while the other terminal thereof is coupled to the filament terminal 7 of the filament of the gas discharge lamp Lp2 that is not connected in series to the filament of the gas discharge lamp Lp1. The auxiliary start capacitor C12 is connected in parallel to the two ends of the gas discharge lamp Lp1, namely, one terminal of the auxiliary start capacitor C12 is coupled to the filament terminal 2 of the filament of the gas discharge lamp Lp1 that is not coupled to the filament of the gas discharge lamp Lp2, while the other terminal thereof is coupled to the coupling point P1 of the filament terminals 4 and 6 of the coupled filaments of the gas discharge lamps Lp1 and Lp2. With respect to a gas discharge lamp cluster composed of more than two gas discharge lamps connected in series, start capacitors of a number corresponding to the number of the gas discharge lamps need to be provided to ensure the normal start of the respective gas discharge lamps in the gas discharge lamp cluster (in which a sum of the numbers of the primary start capacitor and the auxiliary start capacitors equals to the number of the gas discharge lamps). Nevertheless, it is still impossible to ensure complete normal start of the respective gas discharge lamps in the gas discharge lamp cluster without being influenced by the voltage division caused by the series connection, instead, this results in a large volume of the start auxiliary circuit. In order to further ensure the normal start of the respective gas discharge lamps in such a gas discharge lamp cluster, the inductance of the primary start inductor L11 is made to be large in the prior art. However, a large inductance of a primary start inductor L11 will have a large volume, so it increases the difficulty in integration. Moreover, a large inductance of a large primary start inductor L11 will also result in a high manufacturing cost.

FIG. 2 shows a start auxiliary device according to one embodiment of the present invention, which is applied to a gas discharge lamp cluster composed of two gas discharge lamps. The same and similar parts of FIGS. 1 and 2 are indicated by the same reference signs. For the sake of clarity, only the differences between the embodiment of the present invention shown in FIG. 2 and the prior art as shown in FIG. 1 are described below, while the parts that are the same or that have the same functions are not described. The start auxiliary device as shown in FIG. 2 also comprises a primary start circuit, which comprises a primary start capacitor C1 and a primary start inductor L1 which respectively correspond to the primary start capacitor C11 and primary start inductor L11 in the circuit as shown in FIG. 1. The circuit shown in FIG. 2 differs from that shown in FIG. 1 in that it omits the auxiliary start capacitor C12 and adds a step-up unit T1. In FIG. 2, the step-up unit T1 is a three-terminal device, which has a first terminal 101, a second terminal 102 and a third terminal 103. The first terminal 101 and the second terminal 102 of the step-up unit T1 are respectively coupled to the filament terminal 2 of the gas discharge lamp Lp1 and the filament terminal 8 of the gas discharge lamp Lp2 in the gas discharge lamp cluster, and the third terminal 103 thereof is coupled to the coupling point P1 of the filament terminals 4 and 6 of the two gas discharge lamps Lp1 and Lp2. When starting the gas discharge lamps Lp1 and Lp2, the step-up unit T1 is excited by an LC resonant circuit composed of a primary start capacitor C1 and a primary start inductor L1 of the primary start circuit to supply a sufficiently high voltage at the coupling point P1 of the filament terminals 4 and 6 of the gas discharge lamps Lp1 and Lp2. In other words, when the gas discharge lamps Lp1 and Lp2 have substantially the same electrical characteristics, approximately equal voltage differences respectively applying on the gas discharge lamps Lp1 and Lp2 are formed between the third terminal 103 of the step-up unit T1 and the two terminals of the primary start capacitor C1. The voltage differences are evidently higher than the voltages provided by the primary start capacitor C1 and assigned to the gas discharge lamps Lp1 and Lp2 when only the primary start circuit is used, so that voltages that are high enough for start of the gas discharge lamps Lp1 and Lp2 are formed at both ends thereof. Of course, if the respective gas discharge lamps Lp1 and Lp2 have different electrical characteristics (e.g. impedance), the start voltages assigned to the gas discharge lamps Lp1 and Lp2 will be different, that is, the gas discharge lamps Lp1 and Lp2 form a series voltage divider circuit. In addition, the start auxiliary device does not need a primary start inductor L1 with its large inductance, thus saving the manufacturing cost caused by selecting a primary start inductor L1 with its large inductance. It shall also be noted that in several other alternative embodiments, the respective filament terminals of the gas discharge lamps Lp1 and Lp2 may also be shorted together, namely, the filaments 1 and 2 of the gas discharge lamp Lp1 are shorted, the filaments 3 and 4 of the gas discharge lamp Lp1 are shorted, the filaments 5 and 6 of the gas discharge lamp Lp2 are shorted, and the filaments 7 and 8 of the gas discharge lamp LP2 are shorted; or the respective filament terminals of the gas discharge lamps Lp1 and Lp2 may be coupled in any other appropriate ways. The specific way of coupling of the respective filament terminals of the gas discharge lamps is the specific circuit configuration adopted when the start auxiliary device of the embodiment of the present invention is applied to its load, i.e. the gas discharge lamp, which can be chosen or adjusted by those skilled in the art according to the practical requirements (e.g. the electrical characteristics of the gas discharge lamp, the requirements that should be met for driving the gas discharge lamp (such as the requirement for filament protection), etc.) without affecting the realization of the function of the start auxiliary device of the embodiment of the present invention.

FIG. 3 further illustrates a start auxiliary device according to another embodiment of the present invention, which is applied to a gas discharge lamp cluster composed of three gas discharge lamps connected in series. The circuit differs from that shown in FIG. 2 in that the gas discharge lamp cluster is composed of three gas discharge lamps Lp1, Lp2 and Lp3 connected in series, that is, a gas discharge lamp Lp3 is added. The third terminal 103 of the step-up unit T1 is illustratively coupled to the coupling point P1 of the filament terminals 4 and 6 of the gas discharge lamps Lp1 and Lp2. However, the third terminal 103 of the step-up unit T1 can also be coupled to the coupling point P2 of the filament terminals 8 and 10 of the gas discharge lamps Lp2 and Lp3. Whether the third terminal 103 of the step-up unit T1 is coupled to the coupling point P1 or to the coupling point P2, the operation of the start auxiliary device as shown in FIG. 3 is similar to the operation of the start auxiliary device as shown in FIG. 2 that is used in the gas discharge lamp cluster formed of two gas discharge lamps according to the embodiment of the present invention, so they will not be described in detail one by one herein. Likewise, the respective filament terminals of the three gas discharge lamps Lp1, Lp2 and Lp3 as shown in the Figure may be shorted together or be connected in any other appropriate ways without affecting the realization of the function of the start auxiliary device according to the embodiment of the present invention.

FIG. 4 shows a start auxiliary device according to another embodiment of the present invention, which is applied to a gas discharge lamp cluster composed of n gas discharge lamps connected in series (n is a natural number greater than or equal to 2). It is readily understood that the start auxiliary device shown in FIG. 4 is a more general form of the start auxiliary devices as shown in the embodiment of FIGS. 2 and 3. The gas discharge lamp cluster is formed by n gas discharge lamps Lp1, . . . , Lpn successively connected in series. Only the case where one terminal of the series coupling filaments of the n gas discharge lamps Lp1, . . . , Lpn is suspended is shown herein, but this is merely an example which does not intend to make a limitation, and four filament terminals of the series coupling filaments of the n gas discharge lamps Lp1, . . . , Lpn can be coupled together or be coupled in any other ways according to the practical requirements without affecting the realization of the function of the start auxiliary device according to the embodiment of the present invention. In the embodiment shown in FIG. 4, the primary start circuit also comprises a primary start inductor L1 and a primary start capacitor C1 which are coupled in series, and the primary start capacitor C1 is coupled in parallel to the two ends of the gas discharge lamp cluster, i.e. the primary start capacitor C1 is coupled in parallel between the filament terminal 1 of the filament of the gas discharge lamp Lp1 that is not coupled to the filament of the gas discharge lamp Lp2 and the filament terminal 4n−1 of the filament of the gas discharge lamp Lpn that is not coupled to the filament of the gas discharge lamp Lp(n−1). As shown in FIG. 4, the first terminal 101 and the second terminal 102 of the step-up unit T1 are respectively coupled to the two terminals of the primary start capacitor C1 via the filament terminals of the gas discharge lamp Lp1 and gas discharge lamp Lpn in the gas discharge lamp cluster that are not coupled to other gas discharge lamps Lp2, . . . , Lp (n−1). The coupling point E of the filament terminal 1 of the gas discharge lamp Lp1 and the primary start capacitor C1 is coupled to one terminal of the primary start inductor L1, and the other terminal of the primary start inductor L1 forms a feeding input terminal I of the start auxiliary device. In various possible alternative embodiments, the first terminal 101 of the step-up unit T1 can be coupled to the filament terminal 1 or 2 of the filament of the gas discharge lamp Lp1 of the gas discharge lamp cluster and to one terminal of the primary start capacitor C1, the filament of the gas discharge lamp Lp1 being not coupled to other gas discharge lamps Lp2, . . . , Lpn of the gas discharge lamp cluster, and the filament terminals 1 and 2 can be shorted or one terminal thereof is suspended; the second terminal 102 of the step-up unit T1 can be coupled to the filament terminal 4n−1 or 4n of the filament of the gas discharge lamp Lpn and to the other terminal of the primary start capacitor C1, the filament of the gas discharge lamp Lpn being not coupled to other gas discharge lamps Lp1, . . . , Lp(n−1) of the gas discharge lamp cluster, and the filament terminals 4n−1 and 4n can be shorted or one terminal thereof is suspended. The third terminal 103 of the step-up unit T1 of the start auxiliary device is illustratively coupled to the coupling point P1 of the gas discharge lamp Lp1 and the gas discharge lamp Lp2. However, the third terminal 103 of the step-up unit T1 can also be coupled to the coupling point of the filaments of any two gas discharge lamps in the gas discharge lamp cluster. No matter to the coupling point of which two gas discharge lamps in the gas discharge lamp cluster the third terminal 103 of the step-up unit T1 is coupled, the operation of the start auxiliary device as shown in FIG. 4 is similar to the operation of the start auxiliary devices as shown in FIGS. 2 and 3 that are used in the gas discharge lamp cluster, so they will not be described in detail one by one herein.

Preferably, under the condition that the electrical characteristics (e.g. impedance) of the respective gas discharge lamps in the gas discharge lamp cluster are similar, the third terminal 103 of the step-up unit T1 can be coupled to the coupling point of the m^{th} gas discharge lamp and the (m+1)^{th} gas discharge lamp in the gas discharge lamp cluster, in which m=|n/2|(|n/2| represents rounding the values of (n/2)), that is, coupling the third terminal 103 of the step-up unit T1 to approximately the midpoint of the series circuit of the gas discharge lamps, so that the respective gas discharge lamps in the gas discharge lamp cluster could receive more uniform start voltages, thereby avoiding reduction of the service life of the gas discharge lamps that endure higher start voltage owing to the unequal start voltages and further optimizing the start characteristic. It is readily understood that when the electrical characteristics of the respective gas discharge lamps in the gas discharge lamp cluster are quite different, the coupling position of the third terminal 103 of the step-up unit T1 can be chosen according to the principle of making the impedance and the endured start voltage to be matching and uniform, thereby realizing an optimized start characteristic.

Comparing with using one primary start circuit and a plurality of auxiliary start capacitors to start a plurality of gas discharge lamps in the prior art, the start auxiliary device according to the embodiment of the present invention can reliably and efficiently realize start of a plurality of series gas discharge lamps, thereby optimizing the start characteristic. Moreover, the start auxiliary device is simpler and easier to be manufactured because the plurality of auxiliary start capacitors are omitted, accordingly, the manufacturing cost is reduced, too.

It shall be noted that the descriptions about the start auxiliary device according to the embodiments of the present invention with reference to the above FIGS. 2-4 are given in conjunction with the loads, i.e. gas discharge lamps, to which the start auxiliary device according to the embodiments of the present invention can be applied. But those skilled in the art will readily understand that this is only for more clearly describing the operating process and principle of the start auxiliary device according to the embodiments of the present invention rather than making limitation. In other words, the gas discharge lamp cluster in each of the embodiments is not a component of the start auxiliary device according to the embodiment of the present invention, but it is an object to which the start auxiliary device is applied.

FIG. 5a shows a specific example of the step-up unit T1 in the start auxiliary device for the gas discharge lamp cluster according to the embodiment of the present invention. The step-up unit T1 comprises a capacitor C2 and an inductor L2. The capacitor C2 and the inductor L2 are coupled in series and their terminals that are not coupled to each other are respectively the first terminal 101 and the second terminal 102 of the step-up unit T1, the series coupling point thereof forms the third terminal 103 of the step-up unit T1. Suppose that the specific example of the step-up unit T1 as shown in FIG. 5a is applied to the start auxiliary device according to the embodiments of the present invention as shown in FIGS. 2-4, the operation process of the start auxiliary device will be briefly described as follows: the resonant circuit formed by the primary start capacitor C1 and the primary start inductor L1 of the primary start circuit resonates to generate a high voltage at the coupling point of the primary start capacitor C1 and the primary start inductor L1. The high voltage is applied on the step-up unit T1 that is composed of the capacitor C2 and the inductor L2. The resonant circuit formed by capacitor C2 and inductor L2 of the step-up unit T1 produces a resonance while excited by the high voltage provided by the primary start circuit, thereby generating a start voltage at the coupling point 103 of the capacitor C2 and inductor L2, which is higher than the voltage across the two terminals of the primary start capacitor C1. The start voltage forms voltage differences with respect to the two terminals of the primary start capacitor C1. The voltage differences are evidently higher than the voltages provided by the primary start capacitor C1 and assigned to the gas discharge lamps when only the primary start circuit is used, so the start voltages that enable reliable start of the respective gas discharge lamps in the gas discharge lamp cluster can be provided.

FIG. 5b shows a variation of the step-up unit T1 as shown in FIG. 5a, in which the positions of the capacitor C2 and the inductor L2 are interchanged without affecting the realization of the boosting function of the step-up unit T1. The specific operating process thereof is similar to that described above with reference to FIG. 5a, so the details will be omitted herein.

Those skilled in the art should understand that the series resonant circuit formed by the capacitor C2 and the inductor L2 as shown herein may be replaced by any other step-up unit that can provide a boosted voltage at the third terminal 103 while excited by the resonant circuit formed of the primary start capacitor C1 and the primary start inductor L1.

According to the number of the gas discharge lamps in the gas discharge lamp cluster to be driven, the parameters (e.g. the capacitance or inductance) of the primary start capacitor C1 and the primary start inductor L1 in the primary start circuit and the parameters of the capacitor C2 and the inductor L2 in the step-up unit T1 of the start auxiliary device according to the embodiment of the present invention can be determined based on at least one of the following rules: 1) the capacitance of the primary start capacitor C1 and the inductance of the primary start inductor L1 are appropriately chosen so that the resonant point is under the relevant standard of IEC61347-2-3 of gas discharge lamps (usually the inductance is about several millihenries and the capacitance is about several farads); 2) the capacitance of the capacitor C2 and the inductance of the inductor L2 in the step-up unit T1 are chosen to be a little bit smaller than the capacitance of the primary start capacitor C1 and the inductance of the primary start inductor L1 in the primary start circuit; 3) as described above, in a preferred embodiment, if the respective gas discharge lamps in the gas discharge lamp cluster have similar electrical characteristics (e.g. similar impedance), the third terminal 103 of the step-up unit T1 can be coupled to approximately the midpoint of the series gas discharge lamp cluster, then in this case, the capacitor C2 and the inductance L2 are made to have the same impedance in so far as possible, so that the voltage differences of the coupling point 103 at which the capacitor C2 and the inductance L2 are coupled in series in the step-up unit T1 with respect to the two terminals of the primary start capacitor C1 are approximately equal, thereby making the start voltages applied to the respective gas discharge lamps to be uniform. With respect to the specific values of the parameters of the above-mentioned circuit components as well as the specific values of the parameters of other circuit components in the start auxiliary device according to the embodiment of the present invention, they can be set by those skilled in the art according to the specific situation, and the details will not be elaborated herein.

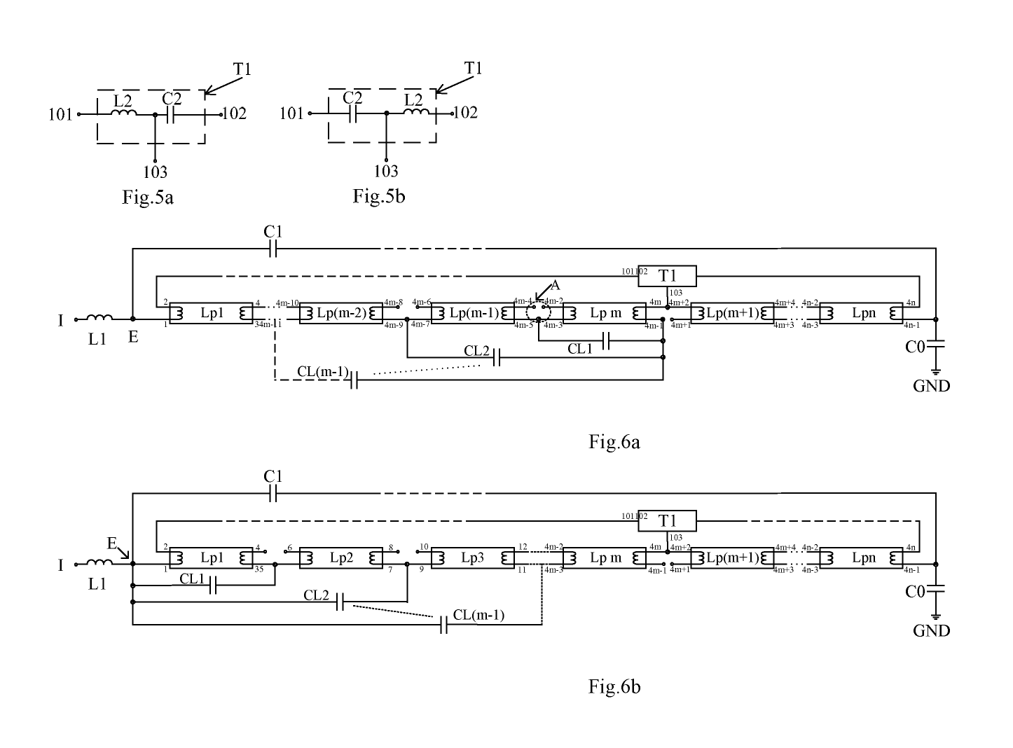

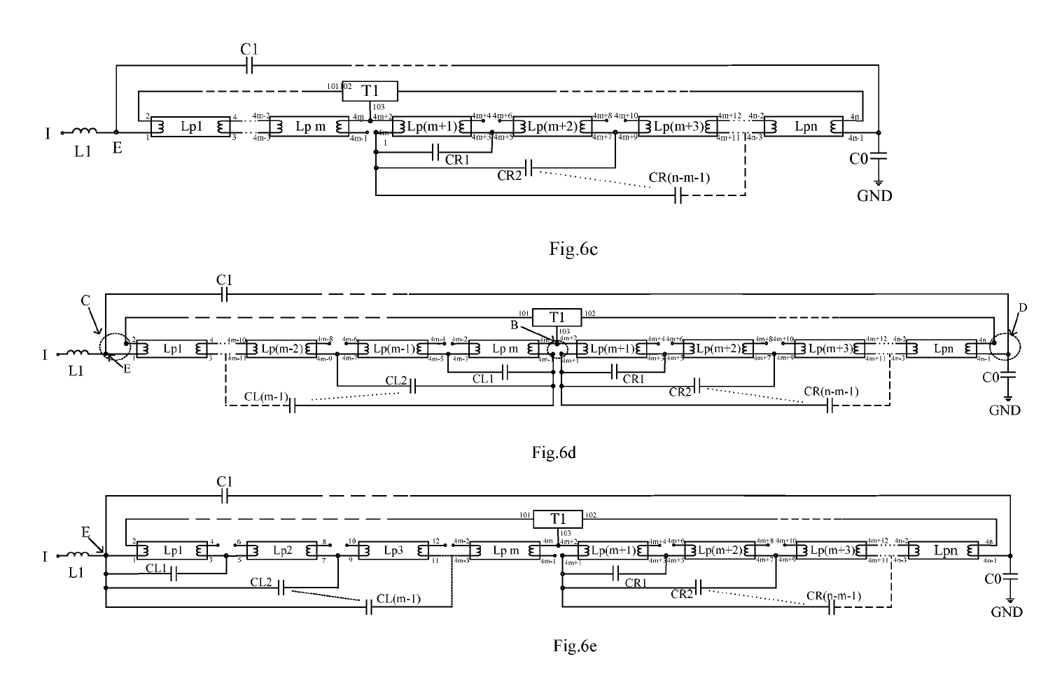

Other variations of the start auxiliary device according to the embodiment of the present invention will be described below with reference to FIGS. 6a-6e.

FIG. 6a shows a start auxiliary device having a plurality of accelerating start units at the left part of the gas discharge lamp cluster according to one embodiment of the present invention, which is applied to a gas discharge lamp cluster formed by n gas discharge lamps connected in series (n is a natural number greater than or equal to 3). The start auxiliary device shown in FIG. 6a differs from that shown in FIG. 4 in that it has a plurality of accelerating start units CL1, CL2, . . . , CL(m−1) provided therein. According to FIG. 6a, the third terminal 103 of the step-up unit T1 divides the gas discharge lamp cluster into two parts, i.e. a left part and a right part. The “left part” and “right part” mentioned herein do not intend to limit the arrangement of the gas discharge lamp in respect of the orientation, but they are only for facilitating the description. The left part of the gas discharge lamp cluster comprises m gas discharge lamps while the right part thereof comprises n−m gas discharge lamps, m being a natural number smaller than n. As shown in the Figure, one terminal of the m−1 accelerating start units CL1, CL2, . . . , CL(m−1) is coupled to the third terminal 103 of the step-up unit T1 via the filament of the m^{th} gas discharge lamp Lpm that is coupled to the (m+1)^{th} gas discharge lamp Lp(m+1), while the other terminal of the m−1 accelerating start units CL1, CL2, . . . , CL(m−1) is coupled to the coupling points between the m gas discharge lamps at the left part, respectively. When excited by the resonance of the primary start circuit, the step-up unit T1 of the start auxiliary device according to FIG. 4 applies the voltage difference between the voltage supplied on the third terminal 103 of the step-up unit T1 and the voltage across the two terminals of the primary start capacitor C1 to each gas discharge lamp (when the respective gas discharge lamps that are connected in series have the same or similar electrical characteristics, the start voltages applying on each of the gas discharge lamps are approximately equal), thus ensuring the start of the respective gas discharge lamps in the gas discharge lamp cluster. In the start auxiliary device as shown in FIG. 6a, when starting the gas discharge lamp cluster, the step-up unit T1 is also excited by resonance of the primary start capacitor C1 and the primary start inductor L1 of the primary start circuit to provide a voltage on its third terminal 103 that is higher than the voltage on the coupling point E of the primary start capacitor C1 and the primary start inductor L1. The voltage supplied by the third terminal 103 is coupled to the coupling points between the respective gas discharge lamps through charging of the respective accelerating start units CL1, CL2, . . . , CL(m−1). In this way, when starting the gas discharge lamp cluster, it is almost equivalent to first directly apply to the two terminals of the gas discharge lamp Lp1 the voltage difference between the voltage on the third terminal 103 of the step-up unit T1 and the voltage on the coupling point E of the primary start capacitor C1 and the primary start inductor L1, so that the gas discharge lamp Lp1 can be quickly started. Then, one the one hand, since the gas discharge lamp Lp1 has been started, it can be approximately considered as a conductor (on which only the voltage matching its impedance fell), so the voltage on one side of the gas discharge lamp Lp2 that is coupled to the gas discharge lamp Lp1 can be approximately considered as being equal to the voltage on the coupling point E of the primary start capacitor C1 and the primary start inductor L1. On the other hand, since the voltage on the third terminal 103 of the step-up unit T1 has been coupled to the other terminal of the gas discharge lamp Lp2 via the accelerating start unit CL(m−2), it is approximately equivalent to directly apply to the two terminals of the gas discharge lamp Lp2 the voltage difference between the voltage on the third terminal 103 of the step-up unit T1 and the voltage on the coupling point E of the primary start capacitor C1 and the primary start inductor L1, so that the gas discharge lamp Lp2 can also be quickly started, similar to the start of the gas discharge lamp Lp1. Likewise, gas discharge lamps Lp3, . . . , Lpm can be quickly started in turn. However, it shall be noted that the above process is very short, so there is not a notable sequence of start when the respective gas discharge lamps are started, that is, the gas discharge lamps can almost be considered as being started simultaneously. It can be seen that the introduction of the accelerating start units further accelerates of the start of the respective gas discharge lamps in the left part of the gas discharge lamp cluster. In addition, although each of the m−1 gas discharge lamps in FIG. 6a is provided with a corresponding accelerating start unit, it is also feasible to provide accelerating start units for only a arbitrary number of the m−1 gas discharge lamps, i.e. accelerating the start of several gas discharge lamps at the left part of the gas discharge lamp cluster, and it is not necessarily that all the m−1 gas discharge lamps must be provided with the corresponding accelerating start units. Even though, the start of the gas discharge lamp cluster can be accelerated as a whole, thus the start characteristic can be further optimized. In other words, at most m−1 accelerating start units can be provided in this situation.

FIG. 6b shows another way of implementation of the start auxiliary device having a group of accelerating start units at the left part of the gas discharge lamp cluster according to one embodiment of the present invention. The start auxiliary device is applied to a gas discharge lamp cluster formed of n gas discharge lamp connected in series (n is a natural number greater than or equal to 3). Compared to the embodiment shown in FIG. 6a, the embodiment shown in FIG. 6b differs in that the m−1 accelerating start units CL1, CL2, . . . , CL(m−1) are respectively coupled between the coupling points between the m gas discharge lamps at the left part of the gas discharge lamp cluster and the coupling point E of the primary start capacitor C1 and the primary start inductor L1 of the primary start circuit. The start auxiliary device shown in FIG. 6b has a similar operating principle as that shown in FIG. 6a, and the difference therebetween only lies in that when the gas discharge lamp cluster is starting, the m−1 accelerating start units CL1, CL2, . . . , CL(m−1) couple the voltage on the coupling point E of the primary start capacitor C1 and the primary start inductor L1 of the primary start circuit to the coupling points between the respective gas discharge lamps at the left part, thereby starting the gas discharge lamp Lpm first, then gas discharge lamps Lp(m−1), Lp(m−2), . . . , Lp1 are started in turn, but the detailed process will not be elaborated herein. The start auxiliary device also further accelerates the start of the respective gas discharge lamps at the left part of the gas discharge lamp cluster. Moreover, a corresponding number of accelerating start units can be provided to some instead of all of the m gas discharge lamps according to the practical requirements.

FIG. 6c shows a start auxiliary device having accelerating start units at the right part of the gas discharge lamp cluster according to one embodiment of the present invention, which is applied to a gas discharge lamp cluster formed of n gas discharge lamp connected in series (n is a natural number greater than or equal to 3). Compared to the embodiment shown in FIG. 6a, the embodiment shown in FIG. 6c differs in that with respect to the m gas discharge lamps (m being a natural number smaller than n) at the right part of the gas discharge lamp cluster, one terminal of the n−m−1 accelerating start units CR1, CR2, . . . , CR(n−m−1) is coupled to the third terminal 103 of the step-up unit T1 via the filament terminal of the (m+1)^{th} gas discharge lamp Lp(m+1) that is coupled to the m^{th} gas discharge lamp Lp(m), while the other terminal thereof is coupled to the coupling points between the n−m gas discharge lamps at the right part, respectively. The start auxiliary device shown in FIG. 6c has a similar operating principle as that shown in FIG. 6a, so it will not be detailed any more. Similar to the embodiment shown in FIG. 6a, the start auxiliary device shown in FIG. 6c further accelerates start of the respective gas discharge lamps at the right part of the gas discharge lamp cluster, thereby further optimizing the start characteristic. Moreover, a corresponding number of accelerating start units can be provided to some instead of all of the m gas discharge lamps at the right part according to the practical requirements.

The embodiment shown in FIG. 6d is obtained from a combination of the embodiments shown in FIGS. 6a and 6c. The start auxiliary device shown in FIG. 6d further accelerates start of the respective gas discharge lamps at the left part and the right part of the gas discharge lamp cluster. Meanwhile, the embodiment shown in FIG. 6e is obtained from a combination of the embodiments shown in FIGS. 6b and 6c, and the start auxiliary device shown in FIG. 6e further accelerates start of the respective gas discharge lamps at the left part and the right part of the gas discharge lamp cluster. For the specific configuration of the start auxiliary devices of the embodiments as shown in FIGS. 6d and 6e and the operation process thereof, reference can be made to the above descriptions with respect to FIGS. 6a-6c, so the details are omitted herein.

In the above embodiments shown in FIGS. 6a-6e, although capacitors are used as example to show the accelerating start units, it does not intend to exclude using other devices that can couple voltage to accelerate the start.

As described above, the start auxiliary device having accelerating start units provided thereto described with reference to FIGS. 6a-6e may have some of its accelerating start units omitted according to the characteristics of the gas discharge lamps connected in series without affecting the realization of the function thereof as a whole. In addition, in a specific embodiment, accelerating start units CL1, C12, . . . , CL(m−1) or CR1, CR2, . . . , CR(n−m−1) having substantially the same capacitance may be chosen. When selecting the capacitance of these accelerating start units, the following two aspects have to be taken into account, i.e. the capacitance of the accelerating start units should be lower than the capacitance of the primary start capacitor C1 in the primary start circuit so as not to affect the resonant frequency of the primary start circuit, and the capacitance of the accelerating start units should be low enough (and accordingly the capacitive reactance is high enough), so that the accelerating start units will not have too much shunting effect on the lamp current of the gas discharge lamp after start of the gas discharge lamp cluster. On the basis of the disclosure of the present invention and the practical application, those skilled in the art will be able to determine the capacitance of the accelerating start units through proper experiments without any inventive labor, and the details will not be described any more.

Furthermore, as shown in FIGS. 2-4 and FIGS. 6a-6e, the gas discharge lamp cluster can be grounded through a DC blocking element such as a capacitor C0 so as to make the start auxiliary device operate more stably. Those skilled in the art should understand that the start auxiliary device according to the embodiment of the present invention can operate normally even if the DC blocking element is not used. Moreover, other components or devices than the DC blocking capacitor C0 that function to DC block may also be used.

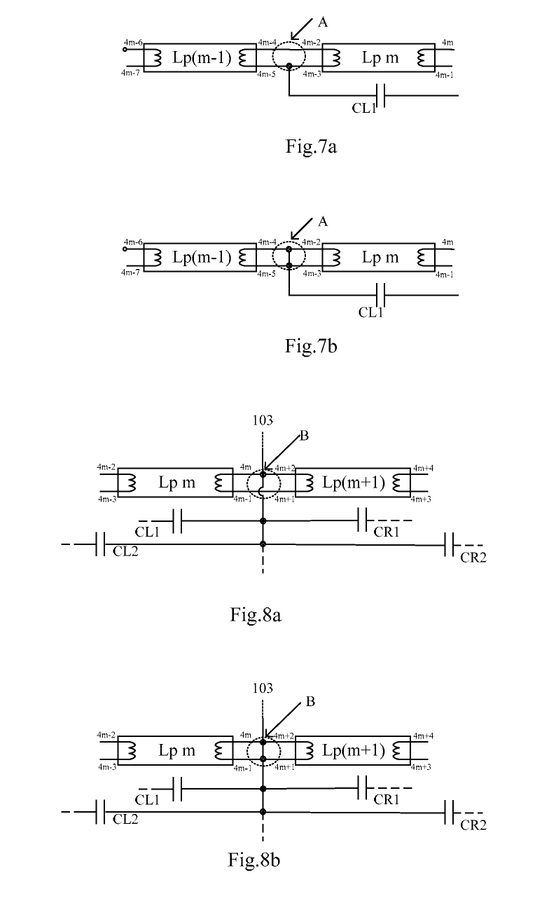

FIGS. 7a and 7b show other two different forms of implementation with respect to the coupling relations shown in the dashed block A in FIG. 6a. FIG. 7a uses gas discharge lamps Lp(m−1) and Lpm as an example to show another coupling relation between the gas discharge lamps and the accelerating start units CL1 in a magnifying form, namely, the filament terminals of the gas discharge lamps Lp(m−1) and Lpm are coupled to form a loop, one terminal of the accelerating start unit is coupled to one coupling point in the loop formed by coupling the filament terminals of the gas discharge lamps Lp(m−1) and Lpm. FIG. 7b also uses gas discharge lamps Lp(m−1) and Lpm as an example to show another coupling relation between the gas discharge lamps and the accelerating start unit CL1 in a magnifying form, namely, four terminals of the filaments of gas discharge lamps Lp(m−1) and Lpm and one terminal of the accelerating start unit CL1 are coupled together. Although FIGS. 7a and 7b illustrate the coupling relations between the filaments of the respective gas discharge lamps and the accelerating start units by taking only the embodiment of FIG. 6a as an example, such coupling relations are also applicable to the respective start auxiliary devices shown in FIGS. 6b-6e, that is, both the left part and the right part of the gas discharge lamp cluster can adopt the coupling relations as shown in FIGS. 7a and 7b to couple the respective gas discharge lamps in the gas discharge lamp cluster to the corresponding accelerating start units. The ways of coupling of the filament terminals of the respective gas discharge lamps can be chosen by those skilled in the art according to the practical requirements (e.g. choosing the way of coupling that can best protect the filament), so this will not be detailed herein.

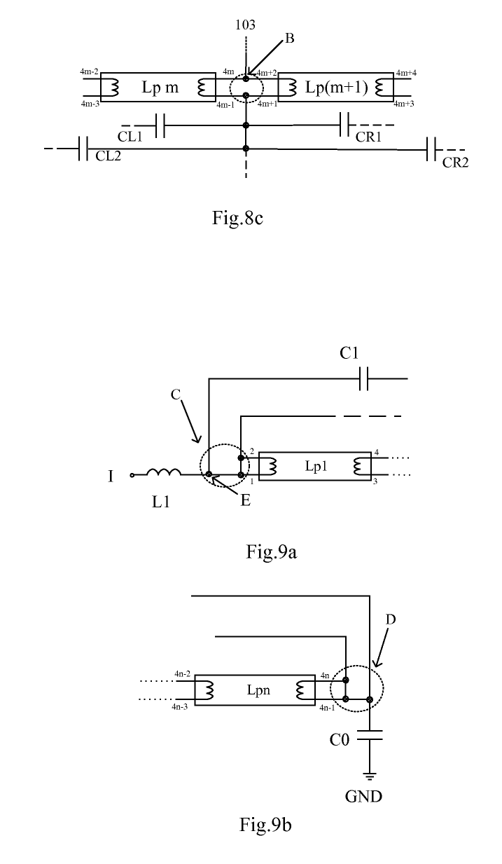

FIGS. 8a, 8b and 8c further show the ways of implementation of the coupling relations among the third terminal 103 of the step-up unit T1, the corresponding filaments of the gas discharge lamps Lpm and Lp(m+1) and the accelerating start units as shown in the dashed block B with respect to the start auxiliary device shown in FIG. 6d. As shown in FIG. 8a, the corresponding filaments of gas discharge lamps Lpm and Lp(m+1) are coupled to form a loop. The third terminal 103 of the step-up unit T1 as well as one terminal of the accelerating start units at the left part and the right part are both coupled to one of the coupling points of the corresponding filaments of the gas discharge lamps Lpm and Lp(m+1). FIG. 8b shows that the terminal 103 of the step-up unit T1, one terminal of the accelerating start units at the left part and the right part and two terminals of the corresponding filament terminals of the gas discharge lamps Lpm and Lp(m+1) (which are filament terminals 4m and 4m−1 of the gas discharge lamp Lpm and filament terminals 4m+2 and 4m+1 of the gas discharge lamp Lp(m+1) herein) are coupled together. FIG. 8c shows that the corresponding filament terminals of the gas discharge lamps Lpm and Lp(m+1) are coupled to form a loop, the third terminal 103 of the step-up unit T1 is coupled to one of the coupling points of the corresponding filaments of the gas discharge lamps Lpm and Lp(m+1), while one terminal of the accelerating start units at the left part and the right part is coupled to another one of the coupling points of the corresponding filaments of the gas discharge lamps Lpm and Lp(m+1).

As shown in the dashed block B in FIG. 6d, the third terminal 103 of the step-up unit T1 and one terminal of the accelerating start units at the left part and the right part are coupled to the corresponding filaments of the gas discharge lamps Lpm and Lp (m+1), so that current may flow through the filaments of the gas discharge lamps before the start of the gas discharge lamps to preheat the filaments, thus the lamps can be started more easily.

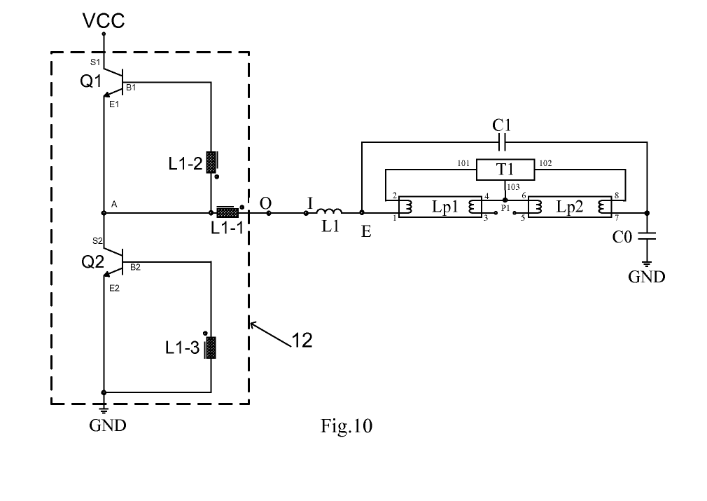

FIGS. 9a and 9b take the embodiment of the start auxiliary device shown in FIG. 6d as an example to further illustrate the way of implementation of the coupling relation between the first terminal 101 of the step-up unit T1 and the corresponding filament of gas discharge lamp Lp1 and the primary start circuit. As shown in FIG. 9a, the two terminals (filament terminals 1 and 2 herein) of the corresponding filament of the gas discharge lamp Lp1 and the first input terminal 101 of the step-up unit T1 are all coupled to the coupling point E of the primary start capacitor C1 and the primary start inductor L of the primary start circuit. As shown in FIG. 9b, the two terminals (filament terminals 4n and 4n−1 of the gas discharge lamp Lpn herein) of the corresponding filament of the gas discharge lamp Lpn are coupled to the second terminal 102 of the step-up unit T1 and the terminal of the primary start capacitor C1 that is not coupled to the primary start inductor L1 of the primary start circuit. It should be understood that although the coupling relations in the dashed blocks C and D are shown herein by taking the start auxiliary device of FIG. 6d as an example, the two coupling relations are also applicable to other embodiments of the present invention.

In addition, the rules of selection of the relevant parameters of the primary start circuit and the step-up unit T1 described with respect to FIGS. 5a and 5b are also applicable to the start auxiliary device as shown in FIGS. 6a-6e.

It shall be noted herein that the gas discharge lamp involved in the descriptions of the start auxiliary device of the embodiments in this specification includes four filament terminals (double filament structure). When it comes to the coupling between the filaments of the respective gas discharge lamps and the filaments of other gas discharge lamps or the coupling between the filaments of the respective gas discharge lamps and the respective components (e.g. the primary start unit, the step-up unit, etc.) of the start auxiliary device according to the embodiments of the present invention, it refers to the various appropriate coupling configuration relations among the filaments of the gas discharge lamps and between the filaments of the gas discharge lamps and other circuit components adopted for realizing the desired circuit functions and structures (the coupling configuration relations being reflected as the coupling relations among the respective gas discharge lamps and between the corresponding filament terminals and other circuit components). Such coupling configuration relations associated with the filaments of the gas discharge lamps can be determined by those skilled in the art according to the practical requirements without any inventive labor. In some specific embodiments, the specific ways of coupling of the corresponding filaments are illustrated by numbering of the filament terminals, but this is only for facilitating a clear and concise description instead of for limiting the invention. With respect to the gas discharge lamps with other filament structures (e.g. a three-filament structure), the above situation is also applicable.

FIG. 10 shows a ballast having the start auxiliary device according to the embodiment of the present invention. The ballast further includes a power supply circuit 12. The output O of the power supply circuit 12 is coupled to the feeding input terminal I of the start auxiliary circuit according to the embodiment of the present invention. The power supply circuit 12 is shown herein by the illustrative and simplest half-bridge inverter. The structure and operation principle of such inverter are familiar to those skilled in the art, so they will not be described in detail any more. The start auxiliary device as shown in FIG. 2 will be used herein as an example to illustrate the ballast of FIG. 10, but the ballast is not limited to the start auxiliary device. For example, the start auxiliary devices shown in FIGS. 3, 4 and 6a-6e as well as the example of the step-up unit T1 shown in FIGS. 5a-5b can be applied to the ballast of FIG. 10. Furthermore, on the basis of the disclosure of the present invention, those skilled in the art can also combine other power supply circuits that can supply power to the gas discharge lamps with the start auxiliary device according to the embodiment of the present invention to assist start of the respective gas discharge lamps in the gas discharge lamp cluster.

In addition, an illumination device can be obtained by applying the ballast according to the embodiment of the present invention as shown in FIG. 10 to an illumination unit. The illumination unit in the illumination device may include a gas discharge lamp cluster formed by a plurality of gas discharge lamps connected in series, the gas discharge lamp cluster being driven by the ballast according to the embodiment of the present invention to at least start the gas discharge lamp cluster, for example.

Although the above embodiments are described in detail by taking a plurality of gas discharge lamps connected in series as an example of the discharge lamp cluster to be driven, those skilled in the art shall understand that the start auxiliary device according to the embodiments of the present invention can also be used for the start of a discharge lamp cluster including mixed connection of series connection and parallel connection. That is, in the cases where the lamp cluster formed by a plurality of gas discharge lamps has a strict requirement on the start voltage upon start, the start auxiliary device according to the embodiments of the present invention can be used. It is readily understood that the start auxiliary device according to the embodiments of the present invention can be used not only in such cases.

It shall be noted that the gas discharge lamps mentioned in this application include high voltage gas discharge lamps and low voltage gas discharge lamps such as fluorescent lamps.

Finally, it shall also be noted that the words “comprise” and “include” or the variants thereof do not mean to be exclusive, so any process, method, article or device that comprises a series of elements comprises not only the series of elements but also other elements that are not listed explicitly or the elements that are inherent in the process, method, article or device. Moreover, where there is no other limitations, the phrase “comprise (include) “a” (“an”) . . . ” preceding an element does not exclude the presence of other such elements in the process, method, article or device that comprise the element.

While the embodiments of the present invention have been described in detail in conjunction with the drawings, it shall be understood that they are merely intend to illustrate rather than limit the present invention. Various modifications and variations to the embodiments will be apparent to those skilled in the art without departing from the substance and scope of the present invention. Therefore, the scope of the present invention is defined by the appended claims and their equivalents.

1. A start auxiliary device for driving a gas discharge lamp cluster, the gas discharge lamp cluster comprising n gas discharge lamps that are successively connected in series, wherein n being a natural number greater than or equal to 2, the start auxiliary device comprising:
a primary start circuit which comprises a primary start capacitor and a primary start inductor that are coupled in series; and
a step-up unit which includes a first terminal, a second terminal, and a third terminal,
wherein the first terminal of the step-up unit is coupled to one terminal of the primary start capacitor via the filament terminal of the first gas discharge lamp of the gas discharge lamp cluster that is not coupled to other gas discharge lamps of the gas discharge lamp cluster, the second terminal of the step-up unit is coupled to the other terminal of the primary start capacitor via the filament terminal of the n^{th} gas discharge lamp that is not coupled to other gas discharge lamps of the gas discharge lamp cluster, the coupling point of the filament of the first gas discharge lamp and the primary start capacitor is coupled to one terminal of the primary start inductor, and the other terminal of the primary start inductor forms a feeding input terminal of the start auxiliary device, and the third terminal of the step-up unit is coupled to the filament terminals of the m^{th} gas discharge lamp and the (m+1)^{th} gas discharge lamp that are coupled to each other, so that the output voltage at the third terminal of the step-up unit is sufficient to supply start voltage for the respective gas discharge lamps in the gas discharge lamp cluster when the step-up unit is excited by the primary start circuit, wherein m≦n−1 and m is a natural number.

2. The start auxiliary device according to claim 1, wherein the step-up unit comprises a capacitor and an inductor that are connected in series, the coupling point of the capacitor and the inductor forms the third terminal of the step-up unit, and the terminals of the capacitor and the inductor that are not coupled to each other form the first terminal and the second terminal of the step-up unit, respectively.

3. The start auxiliary device according to claim 1, wherein the start auxiliary device comprises at most m−1 accelerating start units, which are coupled between the filament terminal of the m^{th} gas discharge lamp that is coupled to the (m+1)^{th} gas discharge lamp and the coupling points among the respective gas discharge lamps from the m^{th} gas discharge lamp to the first gas discharge lamp, respectively, the accelerating start units are used for quickly coupling the output voltage on the third terminal of the step-up unit to the coupling points among the respective gas discharge lamps from the m^{th} gas discharge lamp to the first gas discharge lamp when the gas discharge lamp cluster is starting.

4. The start auxiliary device according to claim 1,
wherein the start auxiliary device comprises at most m−1 accelerating start units, which are coupled between the coupling point of the primary start capacitor and the primary start inductor of the primary start circuit and the coupling points among the respective gas discharge lamps from the first gas discharge lamp to the m^{th} gas discharge lamp respectively, the accelerating start units are used for quickly coupling the voltage on the coupling point of the primary start capacitor and the primary start inductor of the primary start circuit to the coupling points among the respective gas discharge lamps from the m^{th} gas discharge lamp to the first gas discharge lamp.

5. The start auxiliary device according to claim 1,
wherein the start auxiliary device comprises at most n−m−1 accelerating start units, which are coupled between the filament terminal of the m^{th} gas discharge lamp that is coupled to the (m+1)^{th} gas discharge lamp and the coupling points among the respective gas discharge lamps from the (m+1)^{th} gas discharge lamp to the n^{th} gas discharge lamp, respectively, the accelerating start units are used for quickly and in turn coupling the output voltage on the third terminal of the step-up unit to the coupling points among the respective gas discharge lamps from the n^{th} gas discharge lamp to the m+1 gas discharge lamp when the gas discharge lamp cluster is starting.

6. The start auxiliary device according to claim 1,
wherein m=|n/2|, namely, m takes the integral values of |n/2|.

7. The start auxiliary device according to claim 3,
wherein the at most m−1 accelerating start units and the at most n−m−1 accelerating start units are capacitors.

8. The start auxiliary device according to claim 1,
wherein the coupling point of the filament of the n^{th} gas discharge lamp in the gas discharge lamp cluster and the primary start capacitor is coupled to the ground terminal of the start auxiliary device via a DC blocking element.

9. The start auxiliary device according to claim 8, wherein the DC blocking element is a capacitor.

10. A ballast, comprising:
a start auxiliary device for driving a gas discharge lamp cluster, the gas discharge lamp cluster comprising n gas discharge lamps that are successively connected in series, wherein n being a natural number greater than or equal to 2, the start auxiliary device comprising:
a primary start circuit which comprises a primary start capacitor and a primary start inductor that are coupled in series; and
a step-up unit which includes a first terminal, a second terminal, and a third terminal,
wherein the first terminal of the step-up unit is coupled to one terminal of the primary start capacitor via the filament terminal of the first gas discharge lamp of the gas discharge lamp cluster that is not coupled to other gas discharge lamps of the gas discharge lamp cluster, the second terminal of the step-up unit is coupled to the other terminal of the primary start capacitor via the filament terminal of the nth gas discharge lamp that is not coupled to other gas discharge lamps of the gas discharge lamp cluster, the coupling point of the filament of the first gas discharge lamp and the primary start capacitor is coupled to one terminal of the primary start inductor, and the other terminal of the primary start inductor forms a feeding input terminal of the start auxiliary device, and the third terminal of the step-up unit is coupled to the filament terminals of the m^{th} gas discharge lamp and the (m+1)^{th} gas discharge lamp that are coupled to each other, so that the output voltage at the third terminal of the step-up unit is sufficient to supply start voltage for the respective gas discharge lamps in the gas discharge lamp cluster when the step-up unit is excited by the primary start circuit, wherein m≦n−1 and m is a natural number;
wherein the ballast further comprises a power supply circuit, the output terminal of the power supply circuit being coupled to the feeding input terminal of the start auxiliary device so as to supply the electric energy necessary for operation of the start auxiliary device.

11. The ballast according to claim 10,
wherein the power supply circuit is a half-bridge, inverter.

12. An illumination device, comprising:
a ballast, comprising:
a start auxiliary device for driving a gas discharge lamp cluster, the gas discharge lamp cluster comprising n gas discharge lamps that are successively connected in series, wherein n being a natural number greater than or equal to 2, the start auxiliary device comprising:
a primary start circuit which comprises a primary start capacitor and a primary start inductor that are coupled in series; and
a step-up unit which includes a first terminal, a second terminal, and a third terminal,
wherein the first terminal of the step-up unit is coupled to one terminal of the primary start capacitor via the filament terminal of the first gas discharge lamp of the gas discharge lamp cluster that is not coupled to other gas discharge lamps of the gas discharge lamp cluster, the second terminal of the step-up unit is coupled to the other terminal of the primary start capacitor via the filament terminal of the n^{th} discharge lamp that is not coupled to other gas discharge lamps of the gas discharge lamp cluster, the coupling point of the filament of the first gas discharge lamp and the primary start capacitor is coupled to one terminal of the primary start inductor, and the other terminal of the primary start inductor forms a feeding input terminal of the start auxiliary device, and the third terminal of the step-up unit is coupled to the filament terminals of the m^{th} gas discharge lamp and the (m+1)^{th} gas discharge lamp that are coupled to each other, so that the output voltage at the third terminal of the step-up unit is sufficient to supply start voltage for the respective gas discharge lamps in the gas discharge lamp cluster when the step-up unit is excited by the primary start circuit, wherein m≦n−1 and m is a natural number;
a power supply circuit, the output terminal of the power supply circuit being coupled to the feeding input terminal of the start auxiliary device so as to supply the electric energy necessary for operation of the start auxiliary device; and
an illumination unit, the ballast being configured to drive the illumination unit.

13. The illumination device according to claim 12,
wherein the illumination unit comprises a gas discharge lamp cluster formed of a plurality of gas discharge lamps connected in series.

14. The illumination device according to claim 13,
wherein the illumination unit comprises a gas discharge lamp cluster formed of a plurality of gas discharge lamps connected in series and in parallel.

15. The illumination device according to claim 13,
wherein the gas discharge lamp is a fluorescent lamp.
